(19) United States
(12) Patent Application Publication
(10) Pub. No.: US 2019/0369440 A1
(43) Pub. Date: Dec. 5, 2019

(54) DISPLAY APPARATUS

(71) Applicant: Chunghwa Picture Tubes, LTD., Taoyuan City (TW)

(72) Inventors: Chien-Hsun Kuan, Taoyuan City (TW); Jhen-Shen Liao, Taoyuan City (TW); Chih-Chao Chang, New Taipei City (TW); Hung-Hsiang Chen, Taoyuan City (TW)

(73) Assignee: Chunghwa Picture Tubes, LTD., Taoyuan City (TW)

(21) Appl. No.: 16/114,249

(22) Filed: Aug. 28, 2018

(30) Foreign Application Priority Data
Jun. 1, 2018 (CN) 201810557989.4

(51) Int. Cl. G02F 1/1335; H05B 33/08; G09G 3/36; G02F 1/133

(52) U.S. Cl. CPC G02F 1/133603; H05B 33/0845; H05B 33/0818; G09G 2310/08; G02F 1/13306; G02F 1/133606; G09G 2310/0264; G09G 3/3611

(57) ABSTRACT

A display apparatus including a display panel, a backlight plate and a gate driving circuit is provided. The display panel has a plurality of first scan lines and a plurality of source lines. The backlight plate is overlapped with the display panel and has a plurality of second scan lines and a plurality of data lines. The gate driving circuit is coupled to the first scan lines and the second scan lines respectively through a plurality of pins, so as to transmit a plurality of first scan signals respectively to the first scan lines and transmit a plurality of second scan signals respectively to the second scan lines.

### CROSS-REFERENCE TO RELATED APPLICATION

This application claims the priority benefit of China application serial no. 201810557989.4, filed on Jun. 1, 2018. The entirety of the above-mentioned patent application is hereby incorporated by reference herein and made a part of this specification.

### BACKGROUND

### Field of the Invention

The invention relates to a display apparatus and more particularly, to a display apparatus having an array-type backlight plate.

### Description of Related Art

Along the development of high technology, video products, especially digitized videos and image apparatuses, have become common products in normal daily life. A display which currently draws the most attention is a flat-panel display developed by a photoelectric technique and a semiconductor fabrication technique, for example, a liquid crystal display (LCD). The LCD, due to its advantages of low operation voltage, radiation free, light weight and so forth, has become a major subject in the display research.

Conventional LCDs, according to the difference in backlight plate structures, may be classified into two architectures, i.e., a side-light type and a direct type. Current LCDs mostly use a sidelight-type backlight plate, in which light-emitting diodes (LEDs) are disposed at an edge of a backlight module, and a light source is evenly diffused to all regions of the LCD by a reflector, a light guide plate and a diffusion plate. Regarding the direct-type back light, LEDs are equidistantly disposed inside a backlight plate, and the light is evenly dispersed to all regions of the display panel by a light guide plate.

In order to further increase a contrast of the LCD and to achieve a power-saving demand, a local dimming technique has been added into the backlight plate in recently years, namely, a duty cycle of a pulse width modulation (PWM) is adjusted by a control integrated circuit (IC) of the backlight plate, so as to adjust the brightness to different levels for each region of the panel. As the disposition of the LEDs of the backlight plate varies, the local control technique is also restricted in the same way. Because the LEDs of the sidelight-type backlight plate are only disposed at a singe side of the backlight plate, the dimming operation can be only performed in a single coordinate direction while the other side that is far away from the side disposed with the LEDs also has a relatively poor dimming effect. Additionally, in the direct-type backlight plate, as the LEDs are distributed in the backlight plate, they may be positioned in two coordinate directions, so as to dim specific regions.

In the current architecture, as the circuit structure has been fixed during the design phase, the control of the display panel and partitions of the backlight plate cannot be changed freely. Thus, the variety in displaying of the panel will be restricted. If it is assumed that fineness in the displaying of the panel is increased by utilizing the local dimming technique of the backlight plate, a situation that the partitions of the backlight plate must be increased, and synchronously, more LED control ICs must be added into the circuit may occur. Such situation leads to increase in cost and circuit complexity, and driving circuits must be increased and enlarged.

### SUMMARY

The invention provides a display apparatus, and the display apparatus solves the issues of a display panel and a backlight plate through array-type display panel and backlight plate, where the display panel and the backlight plate have fixed display partitions and a display image is restricted thereby.

A display apparatus of the invention includes a display panel, a backlight plate and a gate driving circuit. The display panel has a plurality of first scan lines and a plurality of source lines. The backlight plate is overlapped with the display panel and has a plurality of second scan lines and a plurality of data lines. The gate driving circuit is coupled to the first scan lines and the second scan lines respectively through a plurality of pins, so as to transmit a plurality of first scan signals respectively to the first scan lines and transmit a plurality of second scan signals respectively to the second scan lines.

To sum up, the display apparatus of the embodiments of the invention can not only achieve solving the issue of the display screen being restricted through the array-type display panel and backlight plate, but also allow the display panel and the backlight plate to share the gate driving circuit to reduce the overall cost of the display apparatus. In other words, the embodiments of the invention can achieve adjusting the display screen through the scan lines disposed on the display panel and the backlight plate and coupling the scan lines on the display panel and the backlight plate to the same gate driving circuit (i.e., the same gate integrated circuit (IC)), so as to reduce the cost and the circuit complexity.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a display apparatus according to an embodiment of the invention.

FIG. 2 is a waveform diagram of a gate driving circuit according to an embodiment of the invention.

FIG. 3 is a schematic diagram illustrating a display apparatus according to another embodiment of the invention.

FIG. 4 is a waveform diagram of a display apparatus according to another embodiment of the invention.

FIG. 5 is a schematic diagram illustrating a display apparatus according to another embodiment of the invention.

FIG. 6 is a waveform diagram of a display apparatus according to another embodiment of the invention.

FIG. 7 is a schematic diagram illustrating a display apparatus according to another embodiment of the invention.

FIG. 8 is a schematic structural view of a display apparatus according to an embodiment of the invention.

FIG. 9 is a schematic structural view of a display apparatus according to another embodiment of the invention.

### DESCRIPTION OF EMBODIMENTS

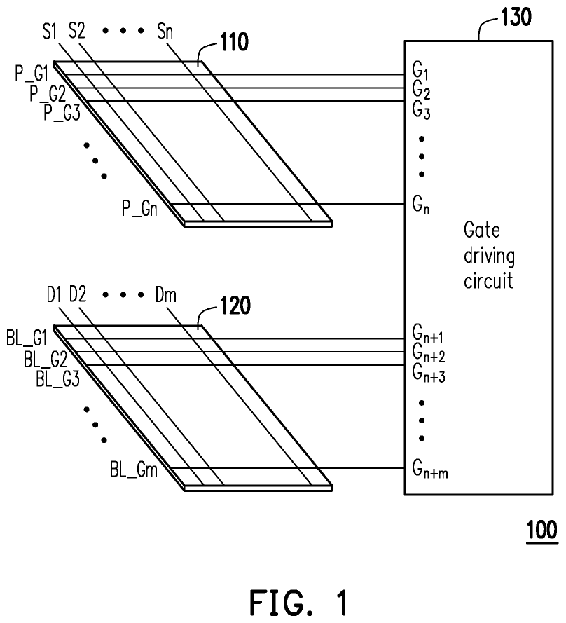

FIG. 1 is a schematic diagram illustrating a display apparatus according to an embodiment of the invention. Referring to FIG. 1, a display apparatus 100 includes a display panel 110, a backlight plate 120 and a gate driving circuit 130. The display panel 110 may be overlapped with the backlight plate 120. The display panel 110 may have a plurality of first scan lines P_G1 to P_Gn and a plurality of source lines S1 to Sn. The backlight plate 120 may have a plurality of second scan lines BL_G1 to BL_Gm and a plurality of data lines D1 to Dm. The first scan lines P_G1 to P_Gn may respectively intersect the source lines S1 to Sn on the display panel 110. The second scan lines BL_G1 to BL_Gm may respectively intersect the data lines D1 to Dm on the backlight plate 120. The gate driving circuit 130 has a plurality of pins, wherein the pins includes a plurality of first pins G₁ to Gₙ and a plurality of second pins Gₙ₊₁ to Gₙ₊ₘ. In the present embodiment, the first pins G₁ to Gₙ of the gate driving circuit 130 may be respectively coupled to the first scan lines P_G1 to P_Gn, and the second pins Gₙ₊₁ to Gₙ₊ₘ of the gate driving circuit 130 may be respectively coupled to the second scan lines BL_G1 to BL_Gm. The gate driving circuit 130 may transmit a plurality of first scan signals to the first scan lines P_G1 to P_Gn respectively through the first pins G₁ to Gₙ and transmit a plurality of second scan signals to the second scan lines BL_G1 to BL_Gm respectively through the second pins Gₙ₊₁ to Gₘ₊ₙ. The gate driving circuit 130 may be disposed in a single integrated circuit (IC). It should be noted that the number of the first pins G₁ to Gₙ may be equal to the number of the second pins Gₙ₊₁ to Gₙ₊ₘ, or alternatively, the number of the first pins G₁ to Gₙ may also be greater than the number of the second pins Gₙ₊₁ to Gₙ₊ₘ, which has no fixed limitations in the invention.

It should be noted here that in the present embodiment, by constructing the gate driving circuit 130 via a single IC, and generating the first scan signals for scanning the display panel 110 and the second scan signals for scanning the backlight plate 120 via the gate driving circuit 130, the complexity of hardware setting of the display apparatus 100 may be simplified, and a layout area as required may be effectively reduced.

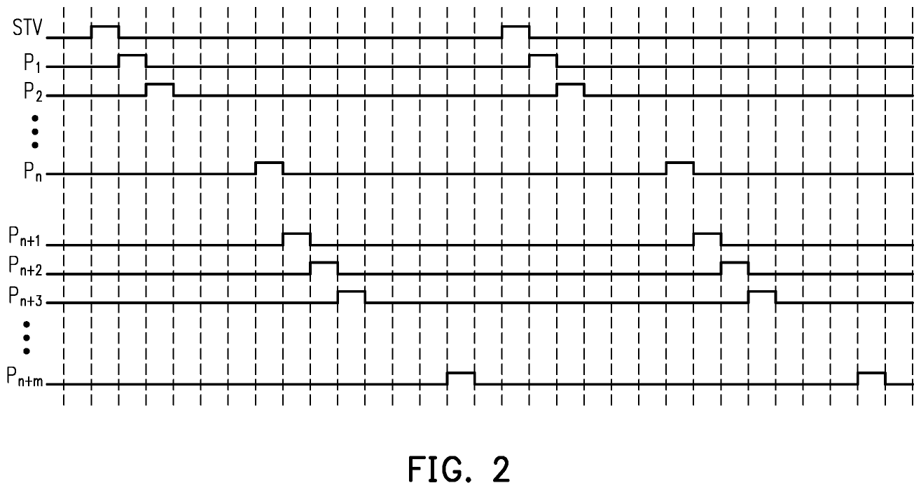

FIG. 2 is a waveform diagram of a gate driving circuit according to an embodiment of the invention. Referring to FIG. 1 and FIG. 2, a timing controller may transmit a first start scan signal STV to the gate driving circuit 130 to trigger the gate driving circuit 130 to generate a plurality of first scan signals P₁ to Pₙ according to the first start scan signal STV. In the present embodiment, the gate driving circuit 130 may sequentially generate the first start scan signals P₁ to Pₙ to the first pins G₁ to Gₙ according to a predetermined time period serving as a delay unit based on the received first start scan signal STV via a shift register, wherein the predetermined time period may be an arbitrarily set time period. To be detailed, the gate driving circuit 130 may delay the first start scan signal STV by a predetermined time period, so as to generate the first one of the first scan signals (which is the 1st first scan signal P₁) to the first one of the first pins (which is the 1st first pin G₁). The gate driving circuit 130 may delay the 1st first scan signal P₁ by a predetermined time period, so as to generate the second one of the first scan signals (which is the 2nd first scan signal P₂) to the second one of the first pins (which is the 2nd first pin G₂). The gate driving circuit 130 may delay the (n−1)th one of the first scan signal P₁ by a predetermined time period, so as to generate the nth one of the first scan signals (which is the nth first scan signal Pₙ) to the nth one of the first pins (which is the nth first pin Gₙ). In this way, the gate driving circuit 130 may sequentially generate the first scan signals P₁ to Pₙ to the first pins G₁ to Gₙ. In addition, the gate driving circuit 130 may provide the last one of the first scan signals (which is the first scan signal Pₙ) generated by the last one of the first pins (which is the first pin Gₙ) as a second start scan signal and generate a plurality of second scan signals Pₙ₊₁ to Pₙ₊ₘ according to the second start scan signal. In other words, the gate driving circuit 130 may sequentially generate the second start scan signals Pₙ₊₁ to Pₙ₊ₘ to the second pins Gₙ₊₁ to Gₙ₊ₘ according to a predetermined time period serving as a delay unit based on the last one of the first start signals (which is the first start signal Pₙ) via the shift register. In detail, the gate driving circuit 130 may delay the last one of the first scan signals (which is the first scan signal Pₙ) generated by the last one of the first pins (which is the first pin Gₙ) by a predetermined time period, so as to generate the first one of the second scan signals (which is the 1st second scan signal Pₙ₊₁) to the first one of the second pins (which is the 1st second pin Pₙ₊₁). The gate driving circuit 130 may delay the 1st second scan signal Pₙ₊₁ by a predetermined time period, so as to generate the second one of the second scan signals (which is the 2nd second scan signal Pₙ₊₂) to the second one of the second pins (which is the 2nd second pin Gₙ₊₂). The gate driving circuit 130 may delay the (m−1)th second scan signal Pₙ₊ₘ₋₁ by a predetermined time period, so as to generate the mth one of the second scan signals (which is the second scan signal Pₙ₊ₘ) to the mth one of the second pins (which is the second pin Gₙ₊ₘ). In this way, the gate driving circuit 130 may sequentially generate the second scan signals Pₙ₊₁ to Pₙ₊ₘ to the second pins Gₙ₊₁ to Gₙ₊ₘ.

Regarding the hardware structure of the gate driving circuit 130, the disposition thereof may be implemented in a manner of chip on glass (COG), chip on film (COF) or gate on array (GOA) of a gate IC which is well known to those skilled in the art.

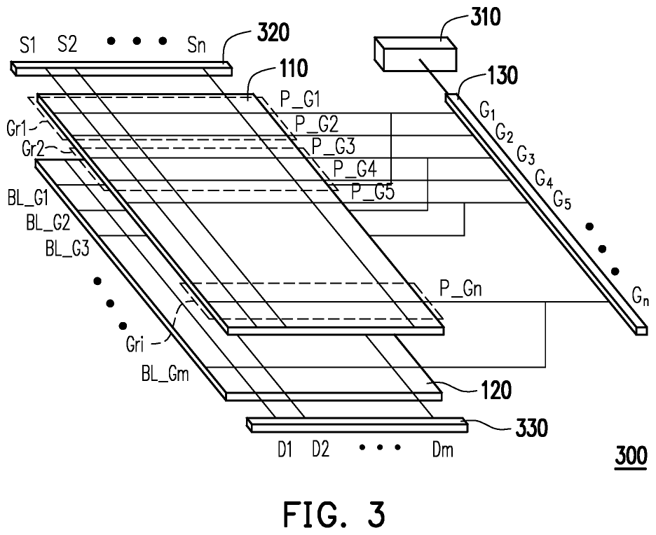

FIG. 3 is a schematic diagram illustrating a display apparatus according to another embodiment of the invention. Referring to FIG. 3, a display apparatus 300 includes a display panel 110, a backlight plate 120 and a gate driving circuit 130. The gate driving circuit 130 may be coupled to first scan lines P_G1 to P_Gn and second scan lines BL_G1 to BL_Gm through first pins G₁ to Gₙ. The number of the first scan lines P_G1 to P_Gn on the display panel 110 may be greater than the number of the second scan lines BL_G1 to BL_Gm on the backlight plate 120. The first scan lines P_G1 to P_Gn may be divided into a plurality of first scan line groups Gr1-Gri. Each of the first scan line groups Gr1 to Gri may include one or more first scan lines. The number of the first scan lines of each of the first scan line groups Gr1 to Gri is not particularly limited. The second scan lines BL_G1 to BL_Gm on the backlight plate 120 may be respectively and directly connected to any one of the first scan lines of each of the first scan line groups Gr1 to Gri. For example, the second scan line BL_G1 may be directly connected to the first one of the first scan lines in the first scan line group Gr1 (which is the first scan line P_G1), the second scan line BL_G2 may be directly connected to the first one of the first scan lines in the first scan line group Gr2 (which is the first scan line P_G3), and the second scan line BL_Gm may be directly connected to the first one of the first scan lines in the first scan line group Gri (which is the first scan line (P_Gn−1)). The second scan lines BL_G1 to BL_Gm on the backlight plate 120 may be further respectively and directly connected to any one of the first scan lines of each of the first scan line groups Gr1 to Gri. For example, the second scan line BL_G1 may be directly connected to the first one of the first scan lines in the first scan line group Gr1 (which is the first scan line P_G1), the second scan line BL_G2 may be directly connected to the second one of the first scan lines in the first scan line group Gr2 (which is the first scan line P_G4), and the second scan line BL_Gm may be directly connected to the second one of the first scan lines in the first scan line group Gri (which is the first scan line P_Gn). Additionally, the gate driving circuit 130 may be directly disposed on an array substrate in a manner of gate driver on array (GOA), thereby omitting a part which a gate driver IC is included. In this way, the cost may be reduced from both the material cost and the fabrication process cost.

In the meantime, the display apparatus 300 may further include a timing controller 310, a source driving circuit 320 and a data circuit 330. The timing controller 310 may be coupled to the gate driving circuit 130 and transmit first scan signals to the gate driving circuit 130. The source driving circuit 320 may be coupled to a plurality of source lines S1 to Sn and sequentially transmit a plurality of source driving signals to the source lines S1 to Sn according to the first scan signals. The data circuit 330 may be coupled to a plurality of data lines D1 to Dm and sequentially transmit a plurality of data signals to the data lines D1 to Dm according to a plurality of second scan signals.

It should be noted here that in the present embodiment, the second scan lines BL_G1 to BL_Gm of the backlight plate 120 may be respectively connected to the first scan line groups Gr1 to Gri of the display panel 110, and thereby, the gate driving circuit 130 may transmit the second scan signals to the second scan lines BL_G1 to BL_Gm without any additional pins, such that the number of the lines of the display apparatus 300 may be reduced to effectively simplify the complexity of the hardware setting.

The data circuit 330 may generate corresponding data signals to the data lines D1 to Dm corresponding to a timing sequence of the second scan lines being enabled, thereby controlling a light-emitting state of the backlight plate 120.

Regarding the hardware structures of the timing controller 310, the source driving circuit 320 and the data circuit 330 of the embodiment of the invention, the timing controller 310 and the source driving circuit 320 may be implemented by applying the timing controller and the source driving circuit of a display apparatus which is well known to those skilled in the art. Regarding the data circuit 330, it may be implemented by using the control circuit of a backlight plate which is well known to those skilled in the art and is not particularly limited.

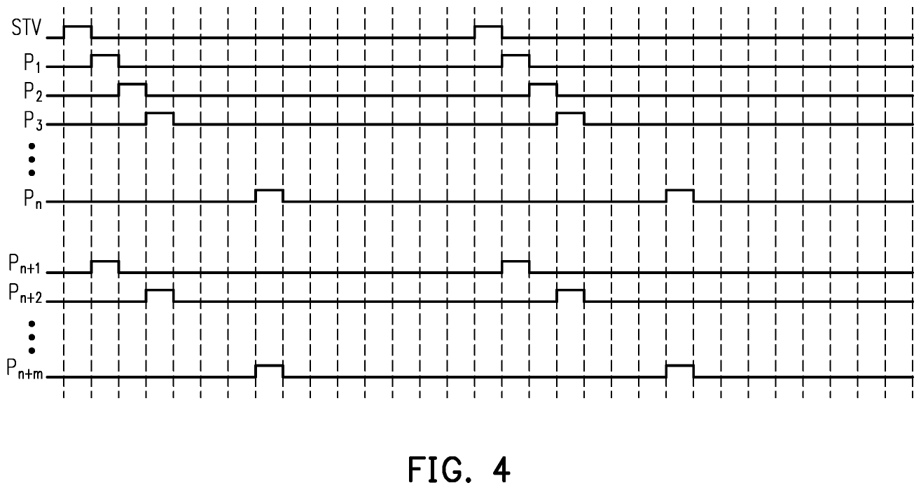

FIG. 4 is a waveform diagram of a display apparatus according to another embodiment of the invention. Referring to FIG. 4, the gate driving circuit may generate second scan signals Pₙ₊₁ to Pₙ₊ₘ partially in synchronization with a part of first scan signals P₁ to Pₙ. For example, the second scan signals Pₙ₊₁ Pₙ₊ₘ may be signals the same as the first scan signals P₁, P₃ . . . and Pₙ. Certainly, in other embodiments of the invention, the second scan signals Pₙ₊₁ to Pₙ₊ₘ may be signals the same as the first scan signals P₂, P₄ . . . and Pₙ. In the present embodiment, m may be less than n.

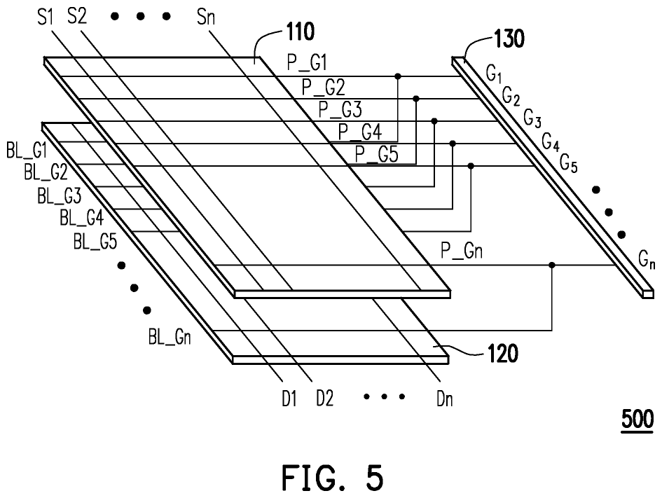

FIG. 5 is a schematic diagram illustrating a display apparatus according to another embodiment of the invention. Referring to FIG. 5, a display apparatus 500 includes a display panel 110, a backlight plate 120 and a gate driving circuit 130. The gate driving circuit 130 may be coupled to first scan lines P_G1 to P_Gn and second scan lines BL_G1 to BL_Gm through first pins G₁ to Gₙ. The number of the first scan lines P_G1 to P_Gn on the display panel 110 of the display apparatus 500 may be equal to the number of the second scan lines BL_G1 to BL_Gn on the backlight plate 120. The second scan lines BL_G1 to BL_Gn on the backlight plate 120 may be respectively and directly connected to the first scan lines P_G1 to P_Gn on the display panel 110. In other words, the second scan lines BL_G1 to BL_Gn on the backlight plate 120 may be directly connected to the first scan lines P_G1 to P_Gn on the display panel 110 in a one-to-one manner. In this circumstance, the first pins G₁ to Gₙ of the gate driving circuit 130 may be directly considered as a plurality of second pins. A plurality of first scan signals generated by the gate driving circuit 130 may also be directly considered as a plurality of second scan signals. Thereby, the gate driving circuit 130 may generate the first scan signals, so as to transmit the first scan signals to the first scan lines P_G1 to P_Gn and the second scan lines BL_G1 to BL_Gn.

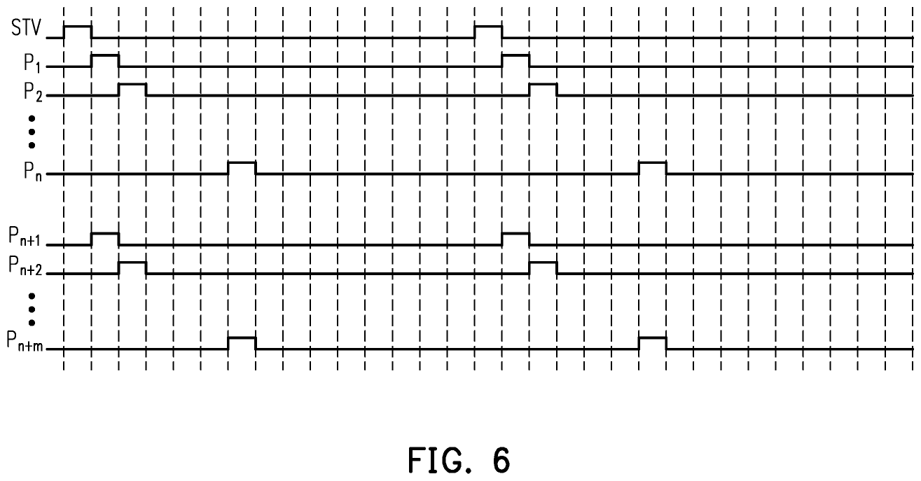

FIG. 6 is a waveform diagram of a display apparatus according to another embodiment of the invention. Referring to FIG. 6, the gate driving circuit may generate second scan signals Pₙ₊₁ to Pₙ₊ₘ completely in synchronization with first scan signals P₁ to Pₙ. For example, in the present embodiment, n may be equal to m, and the second scan signals Pₙ₊₁ to Pₙ₊ₘ may be respectively in synchronization with the first scan signals P₁ to Pₙ.

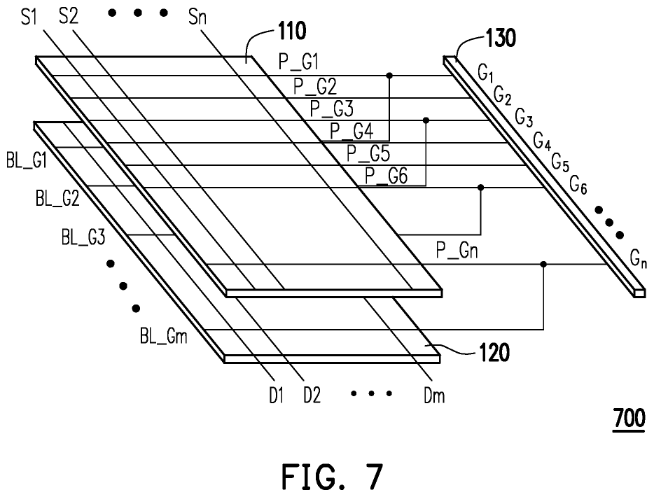

FIG. 7 is a schematic diagram illustrating a display apparatus according to another embodiment of the invention. Referring to FIG. 7, a display apparatus 700 includes a display panel 110, a backlight plate 120 and a gate driving circuit 130. The gate driving circuit 130 may be coupled to first scan lines P_G1 to P_Gn and second scan lines BL_G1 to BL_Gm through first pins G₁ to Gₙ. The number of the first scan lines P_G1 to P_Gn on the display panel 110 of the display apparatus 700 may be greater than the number of the second scan lines BL_G1 to BL_Gm on the backlight plate 120. The number of the first scan lines between each two adjacent second scan lines may be the same, different or partially the same. Referring to FIG. 7, the first scan lines in an arbitrary number may be disposed between each two second scan lines, and the number of the first scan lines disposed between each two second scan lines do not have to be completely the same. For example, there may be one first scan line disposed between the second scan lines BL_G1 and BL_G2, and there may be two first scan lines disposed between the second scan lines BL_G2 and BL_G3. It is to be noted that the description set forth above is not intent to limit the disposition manner of the second scan lines, and in other embodiments, there may be a plurality of first scan lines disposed between the second scan lines BL_G1 and BL_G2, and there may be one, two or more first scan lines disposed between the second scan lines BL_G2 and BL_G3.

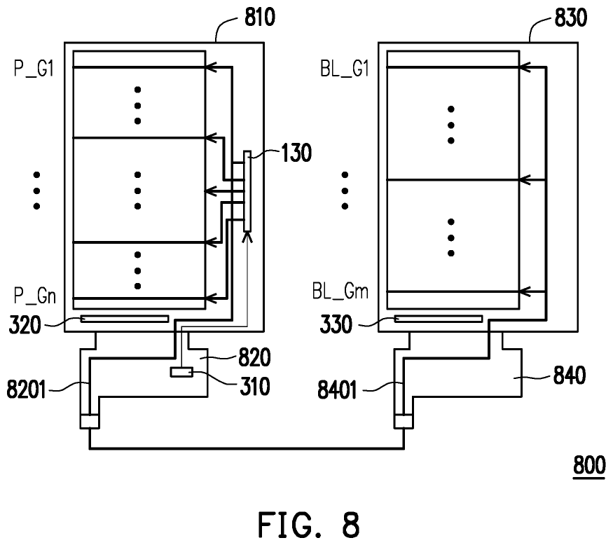

FIG. 8 is a schematic structural view of a display apparatus according to an embodiment of the invention. Referring to FIG. 8, a display apparatus 800 further includes a first circuit board 820 and a second circuit board 840. A display panel 810 is employed to carry the gate driving circuit 130. The first circuit board 820 is coupled to the display panel 810 and has a plurality of first transmission lines 8201. The second circuit board 840 is coupled to a backlight plate 830 and has a plurality of second transmission lines 8401. The first transmission lines 8201 may be coupled to a plurality of second pins which are different from first pins of the gate driving circuit 130 (as illustrated in FIG. 1), or coupled to a part of or all of the first pins of the gate driving circuit 130 (as illustrated in FIG. 3, FIG. 5 and FIG. 7). The second transmission lines 8401 are respectively coupled between the first transmission lines 8201 and the second scan lines BL_G1 to BL_Gm. To be detailed, the gate driving circuit 130 may transmit a plurality of second scan signals to the second circuit board 840 through the first transmission lines 8201, and transmit a plurality of second scan signals to the second scan lines BL_G1 to BL_Gm through the second transmission lines 8401. In addition, the gate driving circuit 130 may be coupled to the first scan lines P_G1 to P_Gn of the display panel 810 in a manner of chip on glass (COG). The first circuit board 820 and the second circuit board 840 may be printed circuit boards (PCBs) or flexible printed circuits (FPCs), which are not particularly limited in the invention. Additionally, the display panel 810 may also be employed to carry a source driving circuit 320, the backlight plate 830 may also be employed to carry the data circuit 330, and the first circuit board 820 may also be employed to carry the timing controller 310, wherein the timing controller 310 may be coupled to the gate driving circuit 130 through the display panel 810.

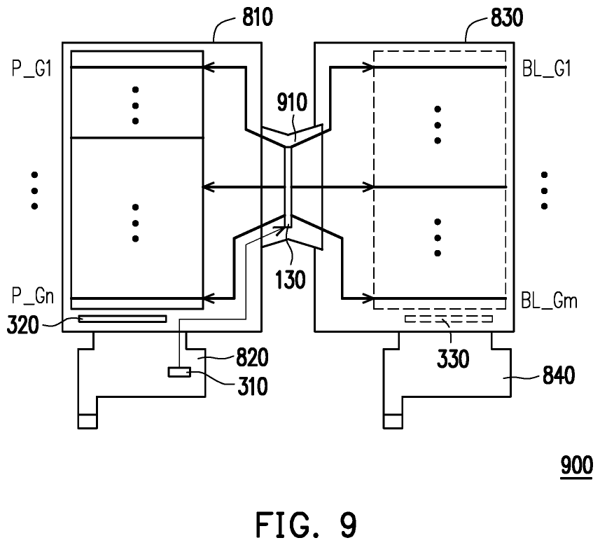

FIG. 9 is a schematic structural view of a display apparatus according to another embodiment of the invention. Referring to FIG. 9, a display apparatus 900 further includes a bridge substrate 910. The bridge substrate 910 is employed to carry the gate driving circuit 130 and coupled between the display panel 810 and the backlight plate 830. The first scan lines P_G1 to P_Gn of the display panel 810 may be coupled to a plurality of first pins of the gate driving circuit 130 through the bridge substrate 910. The second scan lines of the backlight plate 830 may be coupled to a plurality of second pins which are different from the first pins of the gate driving circuit 130 (as illustrated in FIG. 1) through the bridge substrate 910, or coupled to a part of or all of the first pins in the gate driving circuit 130 (as illustrated in FIG. 3, FIG. 5 and FIG. 7). To be detailed, because the bridge substrate 910 is coupled between the display panel 810 and the backlight plate 830, the gate driving circuit 130 may transmit a plurality of first scan signals directly to the first scan lines P_G1 to P_Gn through the bridge substrate 910, and transmit a plurality of second scan signals directly to the second scan lines BL_G1 to BL_Gm through the bridge substrate 910. In addition, the gate driving circuit 130 may be coupled to the first scan lines P_G1 to P_Gn of the display panel 810 and the second scan lines BL_G1 to BL_Gm of the backlight plate 830 in a manner of chip on film (COF). The bridge substrate 910 may be a printed circuit board (PCB) or a flexible printed circuit (FPC), which is not particularly limited in the invention. Additionally, the display panel 810 may also be employed to carry the source driving circuit 320, the backlight plate 830 may also be employed to carry the data circuit 330, and the first circuit board 820 may also be employed to carry the timing controller 310, wherein the timing controller 310 may be coupled to and the gate driving circuit 130 through the display panel 810 and the bridge substrate 910.

Based on the above, the display apparatus of the embodiments of the invention can not only achieve solving the issue of the display screen being restricted through the array-type display panel and backlight plate, but also allow the display panel and the backlight plate to share the gate driving circuit to reduce the overall cost of the display apparatus. In other words, the embodiments of the invention can achieve adjusting the display screen by the scan lines disposed on the display panel and the backlight plate and coupling the scan lines on the display panel and the backlight plate to the same gate driving circuit (i.e., the same gate IC), so as to reduce the cost and the circuit complexity. In addition, a part of the first pins of the gate driving circuit may be selected to serve as the second pins. Thereby, the display apparatus may achieve reducing the number of the overall lines, so as to reduce the cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display apparatus, comprising:
a display panel, having a plurality of first scan lines and a plurality of source lines;
a backlight plate, overlapped with a display panel and having a plurality of second scan lines and a plurality of data lines; and
a gate driving circuit, coupled to the first scan lines and the second scan lines respectively through a plurality of pins, transmitting a plurality of first scan signals respectively to the first scan lines and transmitting a plurality of second scan signals respectively to the second scan lines.

2. The display apparatus according to claim 1, wherein the pins comprise a plurality of first pins and a plurality of second pins respectively coupled to the first scan lines and the second scan lines.

3. The display apparatus according to claim 1, further comprising:
a timing controller, coupled to the gate driving circuit and transmitting a first start scan signal to the gate driving circuit;
a source driving circuit, coupled to the source lines, and sequentially transmitting a plurality of source driving signals to the source lines according to the first scan signals; and
a data circuit, coupled to the data lines, and sequentially transmitting a plurality of data signals to the data lines according to the second scan signals.

4. The display apparatus according to claim 1, wherein the gate driving circuit is configured to:
receive a first start scan signal and generate the first scan signals according to the first start scan signal; and
provide the last one of the first scan signals as a second start scan signal and generate the second scan signals according to the second start scan signals,
wherein the gate driving circuit delays the first start scan signal so as to sequentially generate the first scan signals,
wherein the gate driving circuit delays the second start scan signal so as to sequentially generate the second scan signals.

5. The display apparatus according to claim 1, wherein when the number of the second scan lines is less than the number of the first scan lines, the second scan lines are respectively and directly connected to a part of the first scan lines.

6. The display apparatus according to claim 1, wherein when the number of the second scan lines is equal to the number of the first scan lines, the second scan lines are respectively and directly connected to the first scan lines, and one of the pins is simultaneously connected to one of the first scan lines and one of the second scan lines.

7. The display apparatus according to claim 1, wherein the first scan lines are divided into a plurality of first scan line groups, and the second scan lines are respectively and directly connected to the first scan lines of the first scan line groups.

8. The display apparatus according to claim 7, the number of the first scan lines between each two adjacent second scan lines is the same, different or partially the same.

9. The display apparatus according to claim 1, further comprising:
a first circuit board, coupled to the display panel; and
a second circuit board, coupled to the backlight plate.

10. The display apparatus according to claim 9, the display panel is employed to carry the gate driving circuit, the first circuit board has a plurality of first transmission lines, and the second circuit board has a plurality of second transmission lines,
wherein the first transmission lines are coupled to the display panel, and the second transmission lines are respectively coupled between the first transmission lines and the second scan lines.

11. The display apparatus according to claim 9, further comprising:
a bridge substrate, employed to carry the gate driving circuit and coupled to the display panel and the backlight plate,
wherein the first scan lines are coupled to the display panel through the bridge substrate, and the second scan lines are coupled to the backlight plate through the bridge substrate.
